(19) United States
(12) Patent Application Publication
(10) Pub. No.: US 2012/0129486 A1
(43) Pub. Date: May 24, 2012

(54) Help notification system and method

(75) Inventors: Usman Muhammad Naim, Overland Park, KS (US); Nasir Mahmood Mirza, Overland Park, KS (US); Sameer Akbar Khan, Overland Park, KS (US)

(73) Assignee: Sprint Communications Company L.P.

(21) Appl. No.: 11/274,015

(22) Filed: Nov. 15, 2005

(51) Int. Cl. H04W 4/22; H04W 64/00

(52) U.S. Cl. 455/404.2; 455/404.1

(57) ABSTRACT

A help notification system is provided according to the invention. The help notification system includes a help system adapted to receive a user-initiated help communication from a wireless communication device and a notification system adapted to receive a notification communication from the wireless communication device. The notification system includes an interface configured to receive the notification communication and a processing system in communication with the interface and configured to receive the notification communication from the interface. The processing system is further configured to correlate the notification communication to user information in order to obtain a recipient list, generate a recipient notification communication based on the correlating, and transfer the recipient notification communication through the interface to one or more recipients according to the recipient list.

### BACKGROUND OF THE INVENTION

1. Field of the Invention

The invention is related to the field of notification, and in particular, to a help notification system and a help notification method.

2. Statement of the Problem

Telecommunications are widely used for emergencies. The 911 telephone number is a good example, as it has been widely used for emergency situations and can be used to communicate with police, fire, or medical personnel. Most persons know that in the event of an emergency, they can dial 911 and can immediately summon assistance.

When a person places a call to an emergency telephone number, a dispatcher typically routes the call to an appropriate emergency responder, such as a police, fire, or ambulance department. While this may be adequate in terms of meeting the emergency needs of the person, notification of family and friends is typically performed at a later time. For example, the notification of family is often done by the emergency responder, and after the emergency situation has been addressed or stabilized. As a result, there can be a significant lapse of time before family and friends are notified. However, during this time lapse, family and friends could be available to render assistance, offer comfort, make decisions, etc. Therefore, it is desirable that a person in an emergency situation be able to simultaneously contact emergency personnel and notify family and friends of the situation.

In addition, there may be times when the emergency call to a 911 telephone number cannot be successfully completed. This is more likely for wireless communications (such as cellular telephone service) that for wireline communications. For example, a cellular telephone call to a 911 or E911 (enhanced 911) number can be dropped due to interference, traffic congestion, tower hand-off problems, a nearly out-of-range situation, reception dead zones, low battery, etc.

In the prior art, there are notification services that send notification messages when a 911 call is made. However, if the prior art notification service operates within the telephone network and by triggering off of a 911 call, then the notification may not occur if the 911 call is not successfully established.

### SUMMARY OF THE SOLUTION

A help notification system is provided according to the invention. The help notification system comprises a help system adapted to receive a user-initiated help communication from a wireless communication device and a notification system adapted to receive a notification communication from the wireless communication device. The notification system comprises an interface configured to receive the notification communication and a processing system in communication with the interface and configured to receive the notification communication from the interface. The processing system is further configured to correlate the notification communication to user information in order to obtain a recipient list, generate a recipient notification communication based on the correlating, and transfer the recipient notification communication through the interface to one or more recipients according to the recipient list.

A help notification method is provided according to the invention. The help notification method comprises receiving a user-initiated help communication in a help system from a wireless communication device. The help notification method further comprises receiving a notification communication in a notification system from the wireless communication device. The help communication is received from a wireless communication device. The help notification method further comprises correlating the notification communication to user information in the notification system in order to obtain a recipient list and generating a recipient notification communication in the notification system based on the correlating. The help notification method further comprises transferring the recipient notification communication from the notification system to one or more recipients according to the recipient list.

A help notification method is provided according to the invention. The help notification method comprises receiving a notification communication in a notification system from a wireless communication device and correlating the notification communication to user information in the notification system in order to obtain a recipient list. The help notification method further comprises querying the help system and verifying a help communication connection based on the querying. The help notification method further comprises generating a recipient notification communication in the notification system based on the correlating, with the recipient notification communication including help communication connection information based on the verifying, and transferring the recipient notification communication from the notification system to one or more recipients according to the recipient list.

A help notification method is provided according to the invention. The help notification method comprises receiving a notification communication in a notification system from a wireless communication device and correlating the notification communication to user information in the notification system in order to obtain a recipient list. The help notification method further comprises querying the help system and determining a help communication status based on the querying. The help notification method further comprises generating a recipient notification communication in the notification system based on the correlating, with the recipient notification communication including the help communication status, and transferring the recipient notification communication from the notification system to one or more recipients according to the recipient list.

A help notification method is provided according to the invention. The help notification method comprises generating a user-initiated help communication in a wireless communication device and the wireless communication device transferring the help communication to a help system. The help notification method further comprises generating a notification communication in the wireless communication device and the wireless communication device transferring the notification communication to a notification system. The help notification method further comprises correlating the notification communication to user information in the notification system in order to obtain a recipient list, generating a recipient notification communication in the notification system based on the correlating, and transferring the recipient notification communication from the notification system to one or more recipients according to the recipient list.

### DESCRIPTION OF THE DRAWINGS

The same reference number represents the same element on all drawings.

FIG. 1 shows a help notification system according to an embodiment of the invention.

FIG. 2 is a flowchart of a notification method according to an embodiment of the invention.

FIG. 3 shows a notification system according to an embodiment of the invention.

FIG. 4 is a flowchart of a notification method according to an embodiment of the invention.

FIG. 5 is a flowchart of a notification method according to an embodiment of the invention.

FIG. 6 shows a wireless communication device according to an embodiment of the invention.

FIG. 7 is a flowchart of a notification method according to an embodiment of the invention.

### DETAILED DESCRIPTION OF THE INVENTION

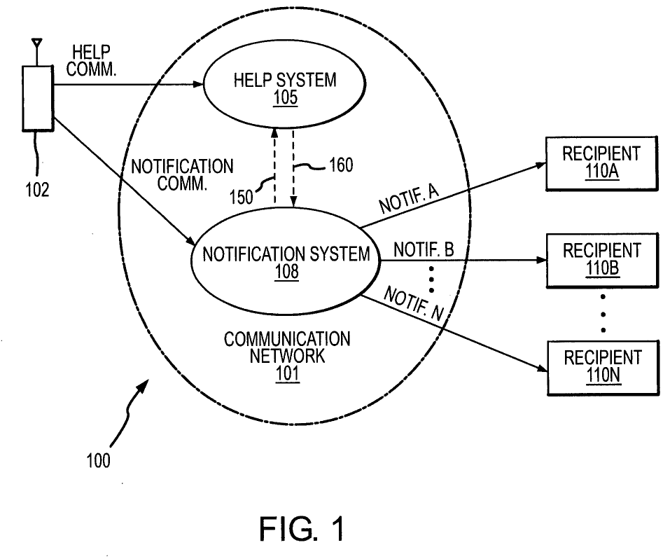

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a help notification system 100 according to an embodiment of the invention. The help notification system 100 can include a communication network 101 that includes a help system 105 and a notification system 108, among other things. The help notification system 100 can further include one or more wireless communication devices 102 and one or more notification recipients 110A-110N.

In operation, the wireless communication device 102 can generate and transfer a help communication to the help system 105. The help communication can be initiated by a user of the wireless communication device 102. The help communication can be initiated by one or more button presses, such as by pressing a special key or by dialing one or more specific help telephone numbers, for example. In addition, the wireless communication device 102 generates a notification communication and transfers the notification communication to the notification system 108. The help communication is received in the notification system 108 directly from the wireless communication device 102, without being passed through some manner of emergency system. The notification communication in one embodiment is triggered by the user-initiated help communication. The generation of the notification communication therefore indicates that the help communication has been generated by the wireless communication device 102.

The help communication transferred to the help system 105 can comprise any message or communication requesting assistance for the user of the wireless communication device 102. For example, the help communication can comprise a 911 (or other N11) emergency telephone call. However, it should be understood that the help communication can comprise other types of messages or communications, such as a roadside assistance message, a message to a medical personnel, etc.

The help communication can comprise an audio message, a text message, or an instant text message, for example. The help communication can comprise a telephone call, and e-mail, a fax, a page, or an instant message (such as a short message service (SMS) message), among other things.

In response to the help communication, the help system 105 can perform an appropriate dispatch or response. If the help system 105 comprises a 911 system, then the help system 105 can contact the appropriate police, fire, or medical agency, for example.

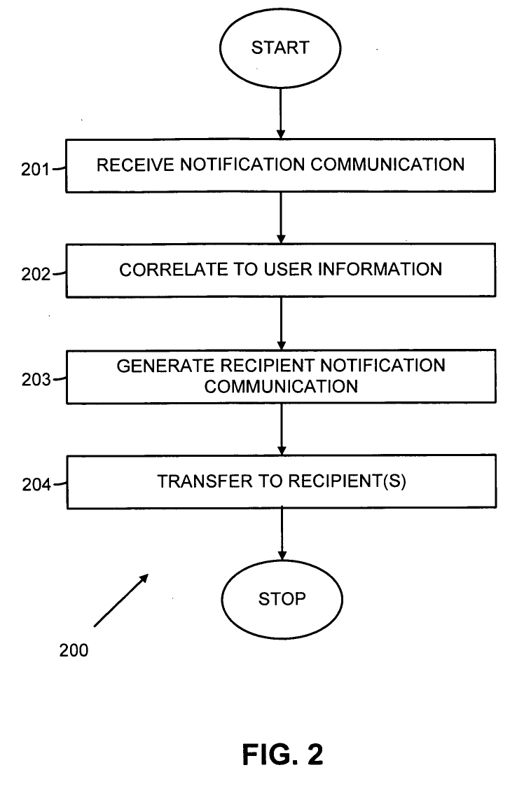

In response to the notification communication form the wireless communication device 102, the notification system 108 can send a recipient notification communication to one or more of the recipients 110A-110N (see FIG. 2 and the accompanying discussion). The recipients can be previously specified by the user of the wireless communication device 102. The notification system 108 therefore alerts one or more recipients 110A-110N that the user of the wireless communication device 102 has generated a help communication. The notification can be immediate and automatic, without any additional effort on the part of the user. This notification therefore provides a valuable benefit to the user during a situation that can involve an emergency of some manner or a situation requiring help. The notification also provides a valuable benefit to the recipients. Even if the situation does not require police, fire, or medical personnel, the notification can provide assistance to the user and/or information to the one or more recipients 110A-10N.

The recipient notification communication can be transferred to the one or more recipients 110A-110N in any manner. The recipient notification communication can include notification information that is transferred to the one or more recipients 110A-110N in the recipient notification communication. The notification information can include user identification, for example. The user identification can comprise any manner of identifier. In one embodiment, the user identification can be generated from a telephone number and/or electronic serial number (ESN) of the wireless communication device 102. The user identification can be generated from a telephone system automatic number identification (ANI) process, for example. However, other identifiers can be used and are within the scope of the description and claims.

The notification information can include time information, such as the time the help communication was initiated by the user, a time of connection and/or completion of the help communication to the help system 105, a time of termination, etc. This time information may be of significance to persons receiving the notification.

The notification information can include a user location (i.e., the location of the wireless communication device 102). The user location can be obtained in any manner, such as through location determination by the wireless communication device 102, by a location determination performed by the associated communication network 101, or both. The user location can be obtained by specialized location system, such as a global positioning system (GPS) or a mobile positioning system (MPS), for example.

The notification information can include a user telephone number (i.e., a telephone number of the wireless communication device 102). The user telephone number in one embodiment can be transmitted to the notification system 108 by the wireless communication device 102. Alternatively, in another embodiment the user telephone number can be generated by an automatic number identification (ANI) process through the communication network 101, for example.

The notification information can include a help communication type. The help communication type can indicate a type of help communication transferred by the wireless communication device 102. In some embodiments, the help communication type can incorporate a help communication priority, wherein the help communication type can indicate a priority set by the user or a priority determined according to a destination of the help communication. The help communication type can reflect a type or level of help needed by the user of the wireless communication device 102. The help communication type can include an emergency or non-emergency type, a 911 call or other N11 call, etc. The help communication type can be determined from the help communication or alternatively can be determined from a query 150 to the help system 105. A query response 160 from the help system 105 can provide information regarding the help communication. Consequently, a notification recipient can receive an approximate idea of the condition of the user.

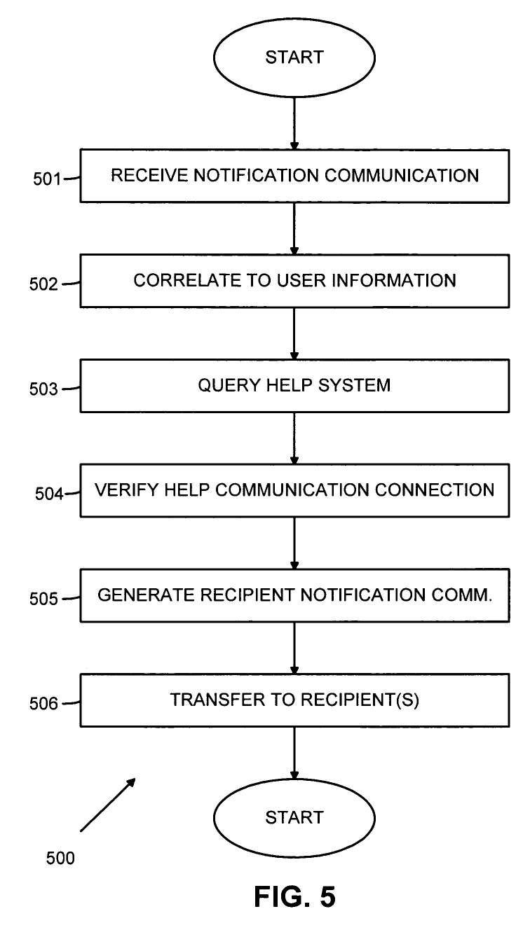

The notification information can include help communication connection information. The help communication connection information can indicate whether the help communication to the help system 105 was successful (see FIG. 5 and the accompanying discussion). As a result, a notification recipient can determine whether the user completed an attempted help communication. In addition, the help communication connection information can include a help communication initiation time, a connection completion time, etc.

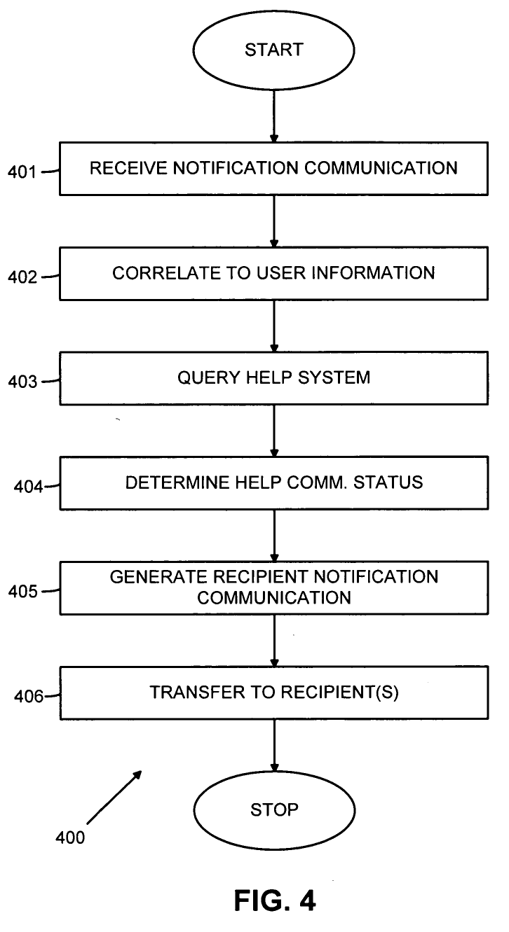

The notification information can include a help communication status that includes the status of the help communication (see also FIG. 4 and the accompanying discussion). The help communication status can include status items generated from the help system 105, including a dispatch status, a units rolling status, a resolution status, etc. It should be understood that these are merely examples, and other types of help communication status can be included in a notification message.

FIG. 2 is a flowchart 200 of a notification method according to an embodiment of the invention. In step 201, the notification system 108 receives a notification communication from the wireless communication device 102. The notification communication is received in the notification system 108 directly from the wireless communication device 102, without being passed through some manner of emergency system. Meanwhile, the wireless communication device 102 also generates a help communication to a help system 105, such as some manner of emergency system. Advantageously, the recipient notification will be performed even if the help call to the help system 105 does not complete, such as in a cellular system wherein a call is dropped because of interference, traffic congestion, tower hand-off problems, a nearly out-of-range situation, reception dead zones, low battery, etc.

In step 202, the notification communication is correlated to user information in order to determine the identity of the user of the wireless communication device 102. The correlation can comprise a process that generates the user identity from the wireless communication device 102 and/or from information stored in the notification system 108. For example, the notification system 108 can obtain a telephone number of the wireless communication device 102. The telephone number can be included in the notification communication or can be obtained through some network process, such as the ANI process previously discussed.

In step 203, a recipient notification communication is generated. In one embodiment, the recipient notification communication is generated in the notification system 108. The recipient notification communication comprises a communication to be sent to one or more recipients 110A-110N.

In step 204, the recipient notification communication is transferred to the one or more recipients 110A-110N. The recipient notification communication can be transferred in any manner, as previously discussed. The recipient notification communication can be transferred to any number of recipients.

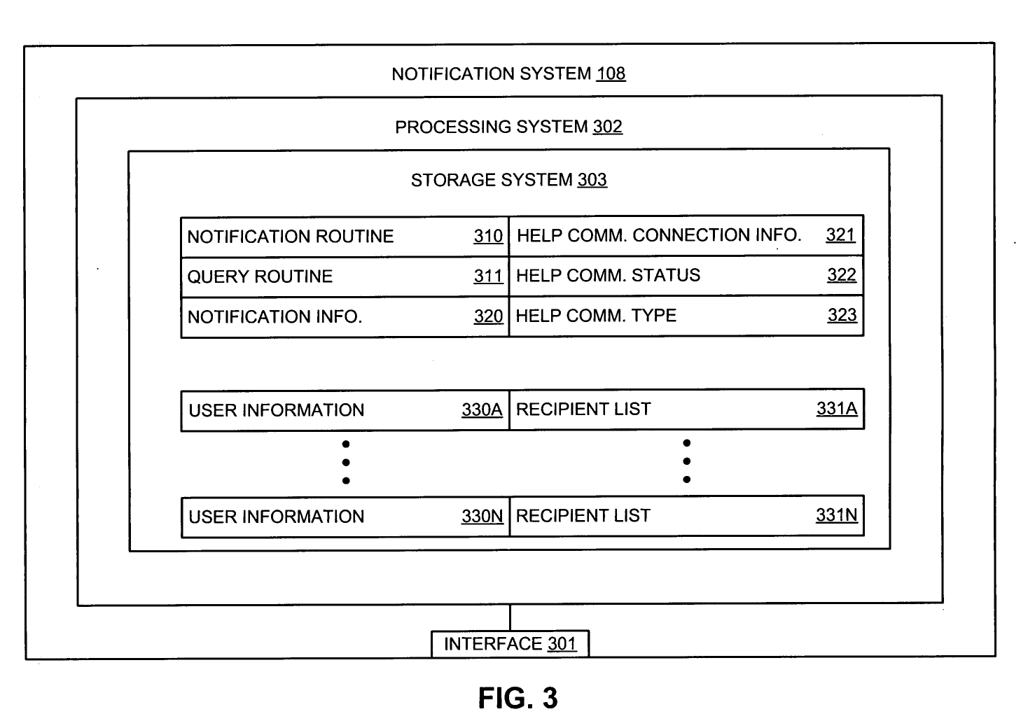

FIG. 3 shows the notification system 108 according to an embodiment of the invention. The notification system 108 can include an interface 301, a processing system 302, and a storage system 303.

The interface 301 communicates with the one or more wireless communication devices 102 and the one or more notification recipients 110A-110N. In addition, the interface 121 can communicate with the help system 105.

The processing system 302 communicates with the interface 301 to transfer and receive messages and data. The processing system 302 executes a notification routine 310, wherein the notification routine 310 performs a notification process according to the invention. In addition, the processing system 302 can retrieve and execute a query routine 311 in order to perform a query operation with the help system 105 according to the invention.

The processing system 302 can generate and store operational data for use in the notification routine 310 and/or in the query routine 311. The operational data can include notification information 320 that stores articles of information for inclusion in a recipient notification communication. The notification information can include one or more of a user identification, a time information, a user location, a user telephone number, a help communication type, a help communication connection information, and a help communication status, as previously discussed. Additional articles of information are contemplated and are within the scope of the description and claims.

The operational data can include help communication connection information 321. The help communication connection information 321 can receive and store connection information about the help call, as previously discussed.

The operational data can include a help communication status 322. The help communication status 322 can receive and store a help communication status, as previously discussed.

The operational data can include a help communication type 323. The help communication type 323 can receive and store a help communication type, as previously discussed.

The operational data can include user information 330A-330N that stores information for each user of the notification system 108. In one embodiment, the users register for or subscribe to the notification system 108. A user can connect to the notification system 108 and add, change, or delete the user data.

The operational data can include recipient lists 331A-331N, with each user information 330x including a corresponding recipient list 331x. A recipient list 331x can store one or more recipients (and contact information) for the corresponding entry of the user information 330x. The users 330A-330N and the recipient lists 331A-331N are therefore used by the notification routine 310 for generating the recipient notification communications.

FIG. 4 is a flowchart 400 of a notification method according to an embodiment of the invention. In step 401, the notification system 108 receives a notification communication from the wireless communication device 102, as previously discussed.

In step 402, the notification communication is correlated to user information in order to determine the identity of the user of the wireless communication device 102, as previously discussed.

In step 403, the notification system 108 queries the help system 105. The query 150 can comprise an appropriate signal or message, for example.

In step 404, the notification system 108 receives a query response 160 and determines a help communication status based on the querying. If no response (or a negative response) is received, the notification system 108 can determine that the help communication was not successfully completed and can relay this help communication status to the one or more recipients. The notification system 108 can perform the querying process multiple times if the help system 105 does not respond (i.e., can re-try a predetermined amount of times). If the help system 105 responds to the querying, the notification system 108 can process the query response 160 and can relay the help communication status to the one or more recipients.

In step 405, a recipient notification communication is generated, as previously discussed. In this embodiment, the recipient notification communication includes the help communication status. As a result, each notification recipient can take appropriate action, based on the help communication status.

In some situations, the help system 105 can be a notification recipient. For example, if the notification system 108 determines that the original help call was not completed to the help system 105, then the notification system 108 can include the help system 105 in the recipient list. A notification communication to the help system 105 can therefore serve to initiate a new help communication.

In step 406, the recipient notification communication is transferred to the one or more recipients 110A-110N, as previously discussed.

FIG. 5 is a flowchart 500 of a notification method according to an embodiment of the invention. In step 501, the notification system 108 receives a notification communication from the wireless communication device 102, as previously discussed.

In step 502, the notification communication is correlated to user information in order to determine the identity of the user of the wireless communication device 102, as previously discussed.

In step 503, the notification system 108 queries the help system 105, as previously discussed.

In step 504, the notification system 108 verifies a help communication connection based on the query. A help communication connection information can be relayed on to the one or more recipients.

In step 505, a recipient notification communication is generated, as previously discussed. In this embodiment, the recipient notification communication includes the help communication connection information. As a result, each notification recipient is informed whether the help communication from the user to the help system 105 was successfully completed. If the help communication was not successfully completed, then a recipient can take further action and can participate in helping the user.

In step 506, the recipient notification communication is transferred to the one or more recipients 110A-110N, as previously discussed.

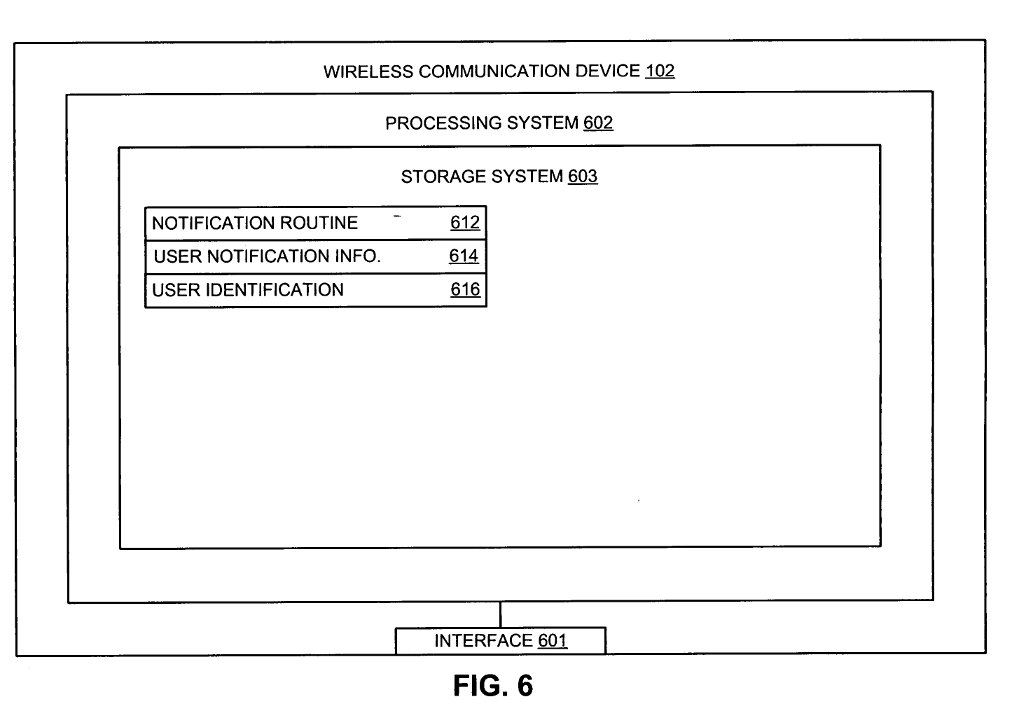

FIG. 6 shows the wireless communication device 102 according to an embodiment of the invention. The wireless communication device 102 can include an interface 601, a processing system 602, and a storage system 603.

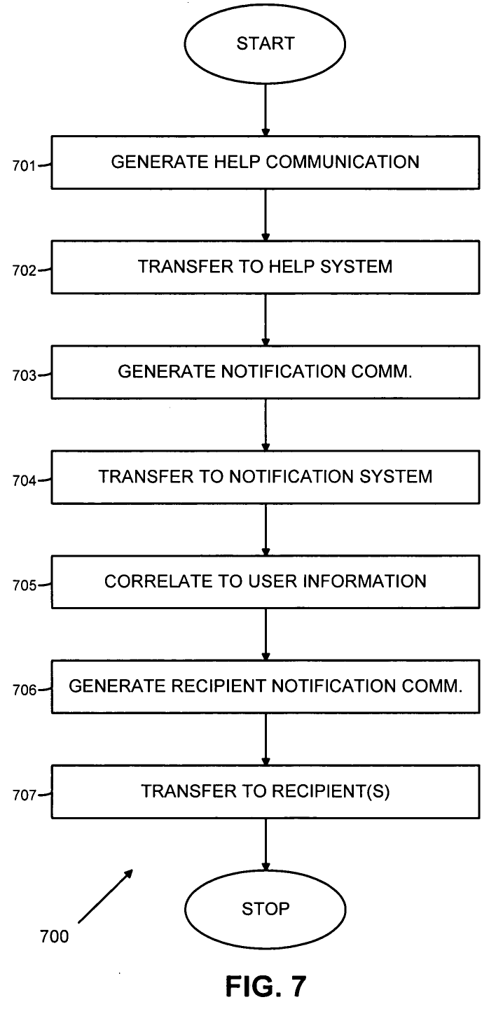

The interface 601 communicates with the communication network 101 and devices and components therein. The processing system 602 communicates with the interface 601 to transfer and receive messages and data. The processing system 602 executes a notification routine 612, wherein the notification routine 612 performs a notification process according to the invention (see FIG. 7 and the accompanying discussion). The processing system 602 (and/or the storage system 603) can further generate and store operational data for use in the notification routine 612. The operational data can include user notification information 614 that stores articles of user information for transfer to the notification system 108. The user notification information 614 can include priority information to be included in a help communication, user location information to be included in the help communication, etc. The processing system 602 (and/or the storage system 603) can further include user identification 616. The user identification 616 can comprise a telephone number or address (such as an IP address, for example) of the wireless communication device 102. The user identification 616 can comprise an electronic serial number (ESN) that is unique to the wireless communication device 102. Other forms of identification are contemplated for the user identification 616 and are within the scope of the description and claims.

FIG. 7 is a flowchart 700 of a notification method according to an embodiment of the invention. In step 701, the wireless communication device 102 generates a user-initiated help communication. The help communication can include any of the information previously discussed.

In step 702, the wireless communication device 102 transfers the help communication to the help system 105.

In step 703, the wireless communication device 102 generates a notification communication. The notification communication can include any of the information previously discussed.

In step 704, the wireless communication device 102 transfers the notification communication to the help system 105, as previously discussed.

In step 705, in the notification system 108, the help call is correlated to user information in order to determine the identity of the user of the wireless communication device 102, as previously discussed.

In step 706, a recipient notification communication is generated in the notification system 108, as previously discussed.

In step 707, the recipient notification communication is transferred by the notification system 108 to the one or more recipients 110A-110N, as previously discussed.

1. A help notification system, comprising:
a help system adapted to receive a user-initiated help communication from a wireless communication device; and
a notification system adapted to receive a notification communication from the wireless communication device generated and transferred by the wireless communication device in response to the user-initiated help communication, with the notification system comprising:
an interface configured to receive the notification communication; and
a processing system in communication with the interface and configured to receive the notification communication from the interface, correlate the notification communication to user information in order to obtain a recipient list, generate a recipient notification communication based on the correlating, and transfer the recipient notification communication through the interface to one or more recipients according to the recipient list.

2. The system of claim 1, with the recipient notification communication including notification information comprising at least a user identification and one or more of a time information, a user telephone number, and a user location.

3. The system of claim 1, with the recipient notification communication including notification information comprising a help communication type.

4. The system of claim 1, with the recipient notification communication including notification information comprising help communication connection information.

5. The system of claim 1, with the recipient notification communication including notification information comprising a help communication status.

6. The system of claim 1, with the notification system being further configured to query the help system, determine a help communication status based on the query, and include the help communication status in the recipient notification communication.

7. The system of claim 1, with the notification system being configured to query the help system, verify a help communication connection based on the query, and include help communication connection information in the recipient notification communication.

8. A help notification method, comprising:
receiving a user-initiated help communication in a help system from a wireless communication device;
receiving a notification communication in a notification system from the wireless communication device generated and transferred by the wireless communication device in response to the user-initiated help communication;
correlating the notification communication to user information in the notification system in order to obtain a recipient list;
generating a recipient notification communication in the notification system based on the correlating; and
transferring the recipient notification communication from the notification system to one or more recipients according to the recipient list.

9. The method of claim 8, with the recipient notification communication including notification information comprising at least a user identification and one or more of a time information, a user telephone number, and a user location.

10. The method of claim 8, with the recipient notification communication including notification information comprising a help communication type.

11. The method of claim 8, with the recipient notification communication including notification information comprising help communication connection information.

12. The method of claim 8, with the recipient notification communication including notification information comprising a help communication status.

13. The method of claim 8, with the method further comprising:
the notification system querying the help system;
determining a help communication status based on the querying; and
including the help communication status in the recipient notification communication.

14. The method of claim 8, with the method further comprising:
the notification system querying the help system;
verifying a help communication connection based on the querying; and
including help communication connection information in the recipient notification communication.

15-24. (canceled)

25. A help notification method, comprising:
generating a user-initiated emergency telephone call in a wireless communication device;
the wireless communication device transferring the user-initiated emergency telephone call to a help system;
generating a notification communication in the wireless communication device in response to generating the user-initiated emergency telephone call;
the wireless communication device transferring the notification communication to a notification system;
correlating the notification communication to user information in the notification system in order to obtain a recipient list;
generating a recipient notification communication in the notification system based on the correlating; and
transferring the recipient notification communication from the notification system to one or more recipients according to the recipient list.

26. The method of claim 25, with the recipient notification communication including notification information comprising at least a user identification and one or more of a time information, a user telephone number, and a user location.

27. The method of claim 25, wherein the notification communication does not comprise an emergency telephone call.

28. The method of claim 25, with the recipient notification communication including notification information comprising emergency telephone call connection information.

29. The method of claim 25, with the recipient notification communication including notification information comprising an emergency telephone call status.

30. The method of claim 25, with the method further comprising:
the notification system querying the help system;
determining an emergency telephone call status based on the querying; and
including the emergency telephone call status in the recipient notification communication.

31. The method of claim 25, with the method further comprising:
the notification system querying the help system;
verifying an emergency telephone call connection based on the querying; and
including emergency telephone call connection information in the recipient notification communication.

32. The system of claim 1 wherein the user-initiated help communication comprises an emergency telephone call.

33. The system of claim 1 wherein the notification communication does not comprise an emergency telephone call.

34. The method of claim 8 wherein the user-initiated help communication comprises an emergency telephone call.

35. The method of claim 8 wherein the notification communication does not comprise an emergency telephone call.
